(19) United States
(12) Patent Application Publication
(10) Pub. No.: US 2009/0053558 A1
(43) Pub. Date: Feb. 26, 2009

(54) Article comprising a thick garnet film with negative growth-induced anisotropy

(75) Inventors: Robert R. Abbott, Westfield, NJ (US); Vincent J. Fratello, Basking Ridge, NJ (US); Steven Joy Licht, Bridgewater, NJ (US); Irina Mnushkina, Randolph, NJ (US)

Correspondence Address: Locke Lord Bissell & Liddell LLP;Attn: Michael Ritchie, Docketing, 2200 Ross Avenue, Suite # 2200, DALLAS, TX, 75201-6776, US

(73) Assignee: Integrated Phototonics, Inc.

(21) Appl. No.: 10/986,985

(22) Filed: Nov. 15, 2004

(51) Int. Cl. C04B 35/40; G02F 1/09; B32B 9/00

(52) U.S. Cl. 428/701; 252/62.57; 359/280; 359/281; 359/282

(57) ABSTRACT

A thick film bismuth doped rare earth iron garnet greater than 50 μm in thickness with a growth-induced uniaxial anisotropy less than zero, such that all the magnetic domains in the film have their magnetization vectors in the plane of the film. A preferred embodiment comprises a film of composition Bi_{1.13}Gd_{1.36}Lu_{0.51}Fe_{4.55}Ga_{0.45}O₁₂. Films with such anisotropy solve the problem of devices and sensors that require a continuously varying Faraday rotation without the effective insertion losses that are inherent to discrete perpendicular domains. A similar effect can be achieved with a film of perpendicular domains by launching the light in the plane of the thick film in a non-waveguiding mode as opposed to the conventional perpendicular direction.

### FIELD OF THE INVENTION

This invention pertains to as-grown and fabricated thick film magnetic garnet crystals (collectively “thick films”) grown by liquid phase epitaxy such that the growth-induced anisotropy is negative and the preferred directions of magnetization are all in the plane of the thick film. The present invention also relates to devices made using non-waveguiding propagation of light in the plane of garnet films.

### BACKGROUND OF THE INVENTION

Liquid phase epitaxy (LPE) is a high temperature solution crystal growth technique used for the growth of films on crystal substrates of the same or nearly the same crystal structure and lattice parameter. It is particularly useful for the growth of complex mixtures. The technique has achieved its greatest success in the growth of complex doped rare earth iron garnet films on simple or doped rare earth gallium garnet substrates. This technique was developed in the 1970's for the growth of thin magnetic garnet films for magnetic bubble applications. The garnet crystal structure is a network oxide with the most complex cubic unit cell in the crystallographic tables consisting of 160 atoms per unit cell. Fortunately the crystal chemistry reduces to a simple formula unit C₃A₂D₃O₁₂. The three C cation sites per formula unit are large dodecahedrally-coordinated sites in the oxygen network that can accommodate large cations such as the rare earths and bismuth. The two A cation sites are moderately sized and octahedrally-coordinated and the three D cation sites are smaller and tetrahedrally-coordinated. The A and D sites frequently contain the same ion such as iron, gallium or aluminum resulting in a simplified expression for the formula unit such as Y₃Fe₅O₁₂ for yttrium iron garnet or YIG.

The rare earth gallium garnet substrate crystals are congruently melting and can be grown in bulk as large single crystals over 100 mm in diameter by the Czochralski technique. They are then sliced and polished into circular substrates 0.3-1 mm thick. These substrates have the advantage of having a high degree of crystalline perfection that can then be imposed on LPE films grown on them. Three of the most common garnet substrate materials for LPE are 1) gadolinium gallium garnet, commonly known as GGG and given the approximate composition of Gd₃Ga₅O₁₂ with a lattice parameter of approximately 12.383 Å, 2) neodymium gallium garnet, commonly known as NdGG and given the approximate composition of Nd₃Ga₅O₁₂ with a lattice parameter of approximately 12.508 Å and 3) a calcium-magnesium-zirconium-substituted GGG (CMZ:GGG) also referred to as a large lattice parameter garnet with an approximately congruently melting composition of Gd_{2.68}Ca_{0.32}Mg_{0.32}Zr_{0.64}Ga_{4.04}O₁₂ and a lattice parameter of approximately 12.498 Å. Films have most commonly been grown on substrates of the (111) orientation, which is not a facet direction and is therefore atomically rough, but some experiments have been done on (100) substrates, which is also not a facet direction. (110) and (211) orientations are facet directions and do not permit the growth of films of good surface quality, but slightly off orientation substrates 0.5-1 degree from the facet direction have been used successfully.

Doped rare earth iron garnets have both cubic magnetocrystalline anisotropy and a uniaxial anisotropy generally relative to the growth direction. The cubic anisotropy is an intrinsic property of any given composition and creates an easy axis along the <111> directions when the first order coefficient K₁ is negative. The cubic magnetocrystalline anisotropy is much less important than the uniaxial anisotropy in defining whether the magnetization is in the plane of the film or out of the plane and will not be discussed further. A full discussion of garnet magnetic anisotropies is given by P. Hansen in Physics of Magnetic Garnets, ed. by A. Paoletti, pp. 56-133 (North-Holland, Amsterdam, 1978)

For a positive uniaxial anisotropy Kᵤ, the magnetization tends to align perpendicular to the plane of the film and along the growth direction. For a negative uniaxial anisotropy, the magnetization tends to align in the plane of the film perpendicular to the growth direction. The uniaxial anisotropy consists of two components, stress-induced and growth-induced. The stress-induced component of anisotropy, Kₛ, is proportional to the mismatch between the film and the substrate with a constant of proportionality that depends on the film elastic properties and the magnetostriction coefficient of the film. The growth-induced component of anisotropy, K_{g}, is dependent on cation ordering along the growth axis, most typically on the dodecahedral C sites.

Growth-induced anisotropy was first understood in terms of pairs of rare earths on the dodecahedral site, ordering according to size and creating anisotropy through a difference in magnetic properties (H. Callen, Applied Physics Letters 18 (1971) p. 311 and A. Rosencwaig, W. J. Tabor and R. D. Pierce, Physical Review Letters 26 (1971) p. 779). Later it was discovered that bismuth doping on the rare earth site could also create growth-induced anisotropy (e.g. P. Hansen and J.-P. Krumme, Thin Solid Films 114 (1984) p. 69) through asymmetric interaction of bismuth with the A and D iron sub-lattices through the intermediate oxygen atoms (P. Novak, Czechoslovakian Journal of Physics B 34 (1984) p. 1060). Pair-wise studies of rare earth-rare earth pairs (E. M Gyorgy, M. D. Sturge, L. G. Van Uitert, E. J. Heilner and W. H. Grodkiewicz, Journal of Applied Physics 44 (1973) p. 438) and bismuth-rare earth pairs (V. J. Fratello, S. E. G. Slusky, C. D. Brandle and M. P. Norelli, Journal of Applied Physics 60 (1986) p. 2488) show that the majority of dodecahedral ionic pairs on (111) oriented substrates create positive Kᵤ. Notable examples of negative growth-induced anisotropy include Nd—Y and Nd—Lu containing garnets on (111) substrates (E. M Gyorgy, M. D. Sturge, L. G. Van Uitert, E. J. Heilner and W. H. Grodkiewicz, Journal of Applied Physics 44 (1973) p. 438) Bi—Pr containing garnets on (111) substrates (V. J. Fratello, S. E. G. Slusky, C. D. Brandle and M. P. Norelli, Journal of Applied Physics 60 (1986) p. 2488) and Bi—Lu containing garnets under certain growth conditions and orientations (R. Hansen and K. Witter, Journal of Applied Physics 58 (1985) p. 454). However, even in the case of negative Kᵤ, truly planar films cannot be created on (111) substrates because the typically negative first cubic anisotropy coefficient, K₁, causes the domain magnetizations to be slightly canted out of the plane of the film, up and down toward the nearby <111> orientations. Substantial development has occurred of (BiLu)₃(FeGa)₅O₁₂ films on (100) oriented GGG substrates for thin-film magnetooptic indicator applications (R. M. Greschishkin, M. Yu. Goosev, S. E. Ilyashenko and N. S. Neustroev, Journal of Magnetism and Magnetic Materials 157/158 (1996) p. 305). These films are grown 2-3 microns thick with small negative growth-induced anisotropies and are used as contact visual sensors of magnetic domains and flux.

The magnetooptic properties or Faraday effect of the rare earth iron garnets are strongly enhanced by bismuth doping through the superexchange and spin-orbit interactions (P. Hansen and J.-P. Krumme, Thin Solid Films 114 (1984) p. 69 and G. F. Dionne and G. A. Allen, Journal of Applied Physics 73 (1993) p. 6127). For this reason, essentially all present magnetooptic garnets are of the approximate composition Bi₁RE₂(FeGaAl)₅O₁₂, commonly called Bi:RIG. The upper limit of bismuth doping is set by the onset of catastrophic misfit dislocations (V. J. Fratello, S. J. Licht, C. D. Brandle, H. M. O'Bryan and F. A. Baiocchi, Journal of Crystal Growth 142 (1994) p. 93). Unlike paramagnetic magnetooptic materials the ferrimagnetic garnets do not have a Verdet constant whereby the magnetooptic rotation is proportional to an applied magnetic field. Instead each magnetic domain acts to rotate the polarization of light passing through it according to the formula θ_{F}=θₛt cos(α) where OF is the total Faraday rotation, θₛ is the specific Faraday rotation per unit length, t is the dimensional length of the path of light propagation through the domain and α is the angle between the light propagation vector P and the magnetization vector M. The angle α is defined by the unit dot product between these two vectors cos(α)=M·P/MP. For the most part, ferrimagnetic Faraday rotators are operated in a single domain magnetically saturated state to avoid multi-domain effects so that the path length t is the thickness in the propagation direction P and M is the bulk magnetization vector.

Growth of thick films with positive growth-induced anisotropy has been perfected for bulk magnetooptic Faraday rotators that operate to give 45 degrees of rotation at the near infrared wavelengths of greatest transparency and greatest interest for telecommunications applications from 1280-1610 nm (V. J. Fratello and R. Wolfe in Magnetic Film Devices, edited by M. H. Francombe and J. D. Adam, Volume 4 of Handbook of Thin Film Devices: Frontiers of Research, Technology and Applications (Academic Press, 2000)). These films must be fabricated to remove the substrate leaving a free-standing, monolithic Bi:RIG single crystal typically 250-550 μm thick. Faraday rotators for the somewhat transparent propagation window near 800 nm are fabricated to approximately 70-80 μm thickness on or off the substrate. Such free-standing films are not subject to stress-induced anisotropy created by a lattice mismatch between film and substrate and only have growth-induced uniaxial anisotropy. Typically a minimum a film thickness of >50 μm is required to fabricate a free-standing film off the substrate. Extensive patent literature in both the United States and Japan covers LPE growth of thick magnetooptic garnet films with perpendicular anisotropy (e.g. Toba et al. Japanese Patent 5-117095, Honda et al. Japanese Patent 6-222311, Sukegawa et al. Japanese Patent 5-339099, Arii et al. U.S. Pat. No. 4,932,760, Shirai et al. U.S. Pat. No. 5,512,193, Shirai et al. U.S. Pat. No. 5,565,131, Brandle et al. U.S. Pat. No. 5,608,570, Fukuda et al. U.S. Pat. No. 5,616,176, Shirai et al. U.S. Pat. No. 5,898,516, Shirai et al. U.S. Pat. No. 6,031,654). Shirai et al (U.S. Pat. No. 5,512,193) discuss the growth of approximately 80 μm films of perpendicular anisotropy, low moment materials on (111) substrates, including compositions of the form (BiGdLu)₃(FeGaAl)₅O₁₂ with extensive restrictions on the compositional ranges of each of the components that place them outside the range of the present invention.

Thin films of Bi:RIG can be made with negative uniaxial anisotropy by annealing the growth-induced anisotropy to zero (V. J. Fratello, S. E. G. Slusky, V. V. S. Rana, C. D. Brandle and J. E. Ballintine, Journal of Applied Physics 59 (1986) p. 564) and using negative stress-induced anisotropy to create in-plane magnetization (R. Wolfe, V. J. Fratello and M. McGlashan-Powell, Applied Physics Letters 51 (1987) p. 1221). Since there is no substrate for thick film Faraday rotators, stress-induced anisotropy is not applicable to the present invention. A zero anisotropy material such as can be achieved by annealing is not suitable for use unless biased with an in-plane magnetic field, which renders the device much larger and ineffective for magnetic field sensor applications.

Thick film Faraday rotator materials with perpendicular anisotropy are typically used in magnetooptic isolators, circulators and other non-reciprocal devices in a fully magnetically saturated, single domain configuration. However, they are also used in sensor, variable optical attenuator, polarization controller and other continuously variable Faraday rotation applications in an unsaturated condition. When no magnetic bias field is applied, the standard perpendicular Bi:RIG films revert to a demagnetized state of serpentine domains (FIGS. 1 and 2). This mixture of “up” and “down” magnetization perpendicular stripe domains is the lowest energy configuration for a material with perpendicular anisotropy. When a perpendicular magnetic field is applied, the domains parallel to the field will expand and those anti-parallels will contract (See FIG. 3). In this way, the average magnetization of the film varies continuously as in the curve in FIG. 4.

The Faraday rotation of the film varies somewhat differently. A light beam passing through the garnet will be rotated in accord with the domains it samples with each domain providing full rotation according to the magnetooptic coefficient and direction of magnetization as discussed above. A beam that is small compared to the domain size would experience essentially a Faraday rotation according to the orientation of the specific domains it passes through, with the overall effect of being random for any distribution of beam locations with a statistical distribution around the proportional distribution of domains. A beam that is large compared to the domain size would experience an average effective Faraday rotation based on the proportion of domains parallel and anti-parallel to the beam. However, the fraction of domains anti-parallel to the beam would contribute a similar fractional loss to the intensity on passing through an analyzing polarizer. For a completely demagnetized case, this would yield an effective absorption or insertion loss of 50% or 3 dB. This loss would slowly decrease with applied magnetic field to the minimal intrinsic absorption of the garnet (typically <0.1 dB or 2.3% and most commonly around 1% for 45 degree rotators at 1310 and 1550 nm) for the fully saturated case. This change in Faraday rotation results from the lateral motion of domain walls. While this configuration has been used for some sensor and variable optical attenuator applications, the large variable insertion loss is prohibitive for high specification devices. For telecommunications applications, this high loss translates to a much shorter distance between repeaters. For sensor applications it yields a strong decrease in sensitivity. For high power applications, the absorption results in significant heating

This problem could be solved by a free-standing, thick film (>50 μm) Bi:RIG Faraday rotator with a negative uniaxial anisotropy. However to date, the conditions to make a good quality thick film and those to make a material with negative uniaxial anisotropy have been mutually exclusive. It is not a simple matter of substituting rare earth ions and substrate orientations because growth of thick films is very difficult and has only been achieved by a few organizations on a few compositions. Growth of any new composition thick film material requires an extensive development program because of the varying activities and distribution coefficients of the different rare earths. Growth conditions and melt chemistry are also important to achieve success of each of these goals. Arii et al. (U.S. Pat. No. 4,932,760) note, for example that (BiLu)₃Fe₅O₁₂ thick films cannot be grown with good quality because of high pit defect densities. Keszei et al. (B. Keszei, Z. Vértesy and G. Vértesy, Crystal Research and Technology 36 (2001) p. 953) and Hansen et al. (R. W. Hansen, L. E. Helseth, A. Solovyev, E. Il'Yashenko and T. H. Johansen, Journal of Magnetism and Magnetic Materials 272-276 (2004) p. 2247) give melt compositions for the growth of thin (BiLu)₃(FeGa)₅O₁₂ magnetooptic indicator films with negative growth-induced anisotropy, but growth of films from these melts requires high undercoolings and high growth rates that result in poor stability of the melt against homogeneous nucleation. Fratello et al. (V. J. Fratello, I. Mnushkina and S. J. Licht in Magneto-Optical Imaging, T. H. Johansen and D. V. Shantsev, eds. (Kluwer, 2004) p. 311) specifically demonstrate that undercoolings of >80° C. are necessary to achieve negative growth-induced anisotropy of (BiLu)₃(FeGa)₅O₁₂ films on (100) substrates. This does not permit growth for long times as is required for thick films, which are typically grown at lower undercoolings (20-40° C.) and slower growth rates (10-20 μm/hour). To date no thick films have been grown with negative growth-induced anisotropy Kᵤ<0.

Waveguide devices have been formulated for thin planar films such that light propagates parallel to the plane of the film (V. J. Fratello and R. Wolfe in Magnetic Film Devices, edited by M. H. Francombe and J. D. Adam, Volume 4 of Handbook of Thin Film Devices: Frontiers of Research, Technology and Applications (Academic Press, 2000)). Thick film devices have only been made to date with light propagating out of the plane of the film (typically such devices are tilted by some small angle from perpendicular to avoid reflections).

### SUMMARY OF THE INVENTION

Thick film bismuth-doped rare earth iron garnet Faraday rotators grown by liquid phase epitaxy with negative or planar growth-induced uniaxial anisotropy. When magnetic fields are applied perpendicular to the plane of the film, all domains will be uniformly rotated toward the film perpendicular, parallel to the applied field. Light propagating perpendicular to the plane of the film will have its polarization rotated uniformly by all domains for all applied fields and for no applied field.

If a light beam is propagated laterally in the plane of the film, it will respond to magnetic fields in the plane of the film. Planar domains rotate even more rapidly in the plane and are very sensitive to small fields making this configuration ideal for sensors for small magnetic fields. This has been used previously only in a waveguiding configuration in thin films. This is an unconventional configuration for a thick film.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 shows a prior art picture of serpentine stripe domains photographed perpendicular to the plane of the film with crossed polarizers to reveal the contrast between domains with their magnetization parallel and anti-parallel to the direction of the propagation of light;

FIG. 2 shows a schematic lateral view of prior art serpentine stripe domains in the demagnetized state with no applied magnetic field, such as are seen in FIG. 1. The vertical arrows show the direction of magnetization in each stripe domain;

FIG. 3 shows the prior art serpentine stripe domains of FIG. 2 with a perpendicular applied bias magnetic field less than saturation. The horizontal arrows show the direction of domain wall motion in response to the magnetic field;

FIG. 4 shows a schematic plot of the magnetization curve (solid, left axis) and light transmission (dashed, right axis) of prior art perpendicular domains as in FIGS. 1-3;

FIG. 5 shows a schematic lateral view of in-plane magnetization domains in a thick film with negative or planar uniaxial anisotropy in the demagnetized state with no applied magnetic field;

FIG. 6 shows in-plane magnetization domains of FIG. 5 with a perpendicular applied bias magnetic field less than saturation. The dotted quarter-circle arrows show the direction of domain rotation;

FIG. 7 shows the magnetization curve (solid, left axis) and light transmission (dashed, right axis) of in-plane domains as in FIGS. 5 and 6 with a perpendicularly applied magnetic field;

FIG. 8 shows a top view of a thick film Faraday rotator with in-plane magnetization domains with both light propagation and applied magnetic field in the plane of the film. The dotted circular arrow shows the direction of domain rotation in response to a rotating magnetic field. A small magnetic field keeps the device fully saturated;

FIG. 9 shows a side view of a thick film Faraday rotator as in FIG. 2 with serpentine stripe domains with both light propagation and applied magnetic field in the plane of the film. The magnetization arrows show that all the domain magnetizations are uniformly canted toward the direction of the magnetic field; and

FIG. 10 shows a schematic drawing of a magnetic field sensor formed from a garnet of planar anisotropy.

### DETAILED DESCRIPTION

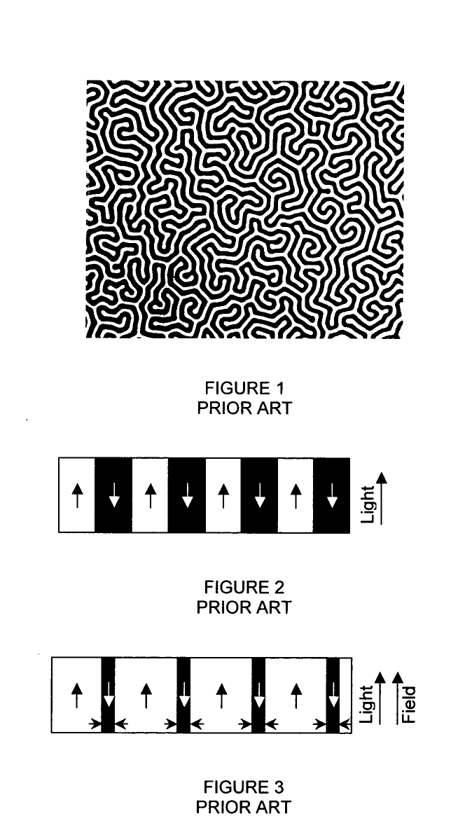

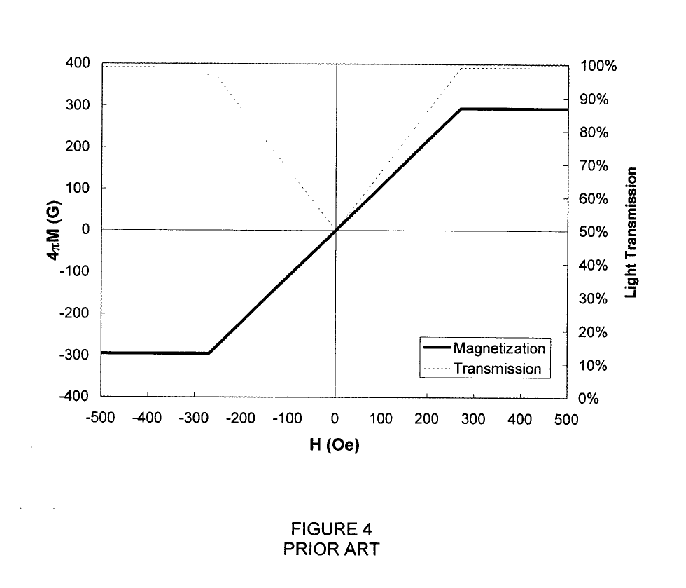

FIGS. 1-3 depict a prior art thick garnet film with positive or perpendicular uniaxial anisotropy. When a magnetic field is applied perpendicular to the plane of the film, the domain walls of the serpentine stripe domains move laterally. This behavior is approximately linear up to the saturation magnetic field as is shown in the schematic magnetization curve (left axis) of FIG. 4. Such a curve is measured, for example, on a vibrating sample magnetometer and represents the average magnetization of the entire film as a function of applied field.

As discussed in the Background of the Invention, light passing through the film approximately perpendicular to the major surface of the film and parallel/anti-parallel to the domain magnetizations will experience a rotation of polarization that is proportional to the magnetization curve of FIG. 4 if a large number of domains are sampled by the beam. Typically Faraday rotator thick film garnets are fabricated to have 45 degrees of Faraday rotation at the wavelength of device operation when fully magnetically saturated. For such a film there will be a variable effective insertion loss with applied field as is also shown in FIG. 4 (right axis). The large 50% loss at zero field and the variability of insertion loss are severe problems in utilizing thick films with perpendicular positive uniaxial anisotropy for variable applied field and variable polarization rotation applications.

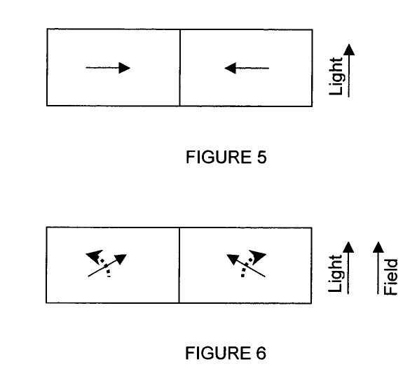

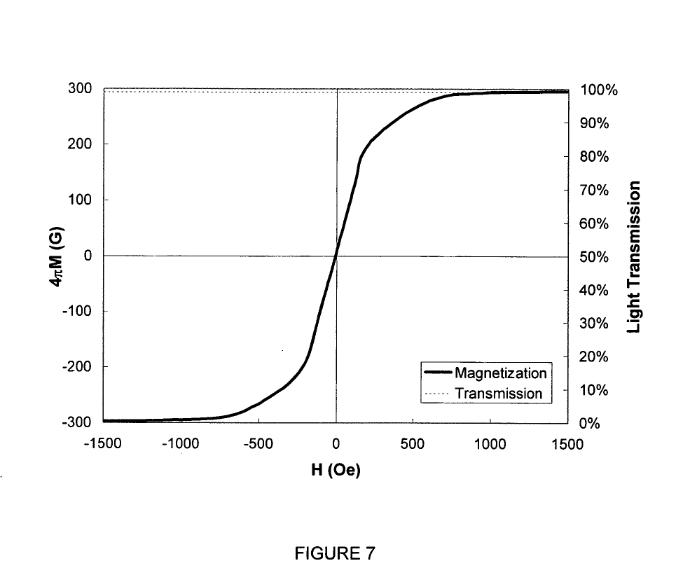

FIG. 5 depicts in-plane domains in a film with negative or planar uniaxial anisotropy. FIG. 6 shows how those domains rotate toward perpendicular when a perpendicular magnetic field is applied. Because of the cubic magnetocrystalline anisotropy and domain end effects, the response of the film magnetization to an applied field is not perfectly linear. This can be seen from the magnetization curve in FIG. 7 (left axis). However, this nonlinearity can be compensated electronically. Magnetization change by domain rotation is also reportedly faster than lateral domain wall motion as is required for films with positive or perpendicular anisotropy (V. I. Butrim, V. G. Vishnevskii and S. V. Dubinko, Techical Physics 46 (2001) p. 427).

Because the magnetization vectors of all the domains have the same dot product with the light propagation vector (approximately perpendicular to the film), the Faraday effect is the same for all the domains no matter what the lateral component of magnetization. The Faraday rotation is again proportional to the magnetization curve. However, the effective insertion loss now goes to the minimum value of approximately 1% (99% transmission) for all applied magnetic fields as is seen in FIG. 7 (right axis).

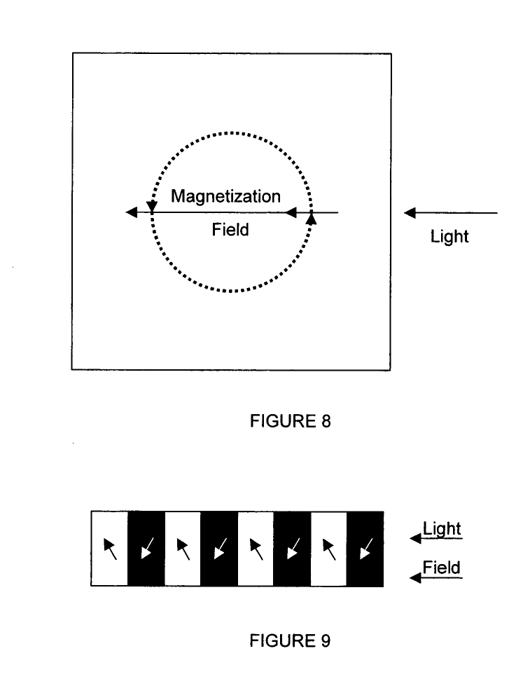

FIG. 8 shows how the lateral propagation of light in the plane of a thick film can be used with a fully saturated film of negative planar uniaxial anisotropy. Because the film saturates readily in the plane of the film, a very small rotating field (<10 Oe) can be used to keep it in a single domain planar configuration. Also a small static magnet such as a thin film magnet deposited on the garnet surface can be used to create an initially saturated state for sensor applications without interfering with the field being sensed.

FIG. 9 shows how the lateral propagation of light in the plane of the thick film can be used with a film of positive perpendicular uniaxial anisotropy. This achieves the same effect as perpendicular propagation of light through a film of negative planar anisotropy. All the domains will rotate uniformly towards perpendicular in the plane of the film and along the direction of magnetization. Because of end effects, this also is not completely linear.

The following bismuth/rare earth combinations have been tested for thick film growth with varying degrees of gallium and aluminum substitution on the iron sites. The gallium and aluminum substitution is commonly understood to adjust the saturation magnetization of the film, but does not primarily influence the growth-induced anisotropy other than by dilution. Therefore only the dodecahedral compositions will be discussed. The initial assumption was that the growth-induced anisotropy would be the sum of the pair-wise anisotropies of all the dodecahedral pairs, but threefold interactions were also observed.

Bi—Nd—Ho on (111) CMZ:GGG substrates. As per the prior art, the combination of Nd and a smaller ion such as Ho produce a large negative growth-induced anisotropy on (111) substrates sufficient to overwhelm the small Bi—Ho anisotropy (Bi—Nd produces no contribution). However the cubic magnetocrystalline anisotropy prevents these domains from being truly planar and they are canted out of the plane of the film. Nd—Ho gives a large positive anisotropy on (100) substrates.

Bi—Pr—Y on (100) CMZ:GGG substrates. As per the prior art, Pr combined with both Bi and Y gives a negative uniaxial anisotropy. However Pr has a large cubic magnetocrystalline anisotropy that distorts magnetization behavior, has a significant absorption in the near infrared wavelengths of primary interest and has a large damping factor that will slow the speed of magnetization rotation.

Bi—Lu films on GGG substrates produce canted planar films on (111) substrates at small undercoolings and highly defective planar films on (100) substrates at high undercoolings.

Bi—Gd—Lu films on (100) CMZ:GGG substrates produced films of as good a crystalline quality as the substrate. The films are completely planar and the negative growth-induced anisotropy can be tuned through the Gd/Lu ratio. The Gd—Lu contribution on (100) substrates is large and negative, but even so the negative growth-induced anisotropy exceeded the value expected from the sum of the Bi—Gd, Bi—Lu and Gd—Lu contributions. Therefore there are three-way ordering and magnetic effects that produce very favorable negative growth-induced anisotropies. The negative K_{g} is also complexly influenced by growth conditions; melt chemistry and iron substitution so no absolute optimum Gd—Lu ratio can be given. Additionally, different applications require a different negative value of K_{g}. Therefore each melt composition should be tuned to give the desired properties.

Based on an understanding of anisotropy, the following conditions give optimized thick film planar magnetooptic films. The dodecahedral site is populated with a combination of Bi, a large rare earth, a small rare earth and possibly minority constituents and impurities. Large rare earths include the elements La, Sm, Eu, Gd, Tb, Dy, Ho and Y (not technically a rare earth, but grouped with them chemically and magnetically). Small rare earths (depending on the choice of large rare earth) include the elements Dy, Ho, Y, Er, Tm, Yb and Lu. Some rare earths are preferred for reasons of good distribution coefficients, low magnetic damping for high speeds and no absorption at the wavelengths of interest, including Gd, Y, Yb and Lu. Therefore preferred combinations are Gd—Y, Gd—Yb, Gd—Lu, Y—Lu and Y—Yb. Depending on the properties desired, the larger rare earths are either the majority or minority constituent.

The ideal bismuth concentration for near infrared applications is 0.5-1.5 atoms per formula unit. The lattice parameter of the film is somewhat tuned by adjusting the Bi concentration and the ratio Ga/Al in iron substitution or by some additional dopants such as In or Sc. However the choice of composition is made interactively with available substrates. Generally available materials such as GGG, NdGG and CMZ:GGG were discussed in the prior art and other pure and substituted rare earth gallium garnets can be grown to give a rich variety of lattice parameters. (100) orientation is preferred for the current applications. (111) is generally not preferred because of domain canting. Other orientations such as slightly misoriented (110), slightly misoriented (211) and (210) are contemplated, but growth is not restricted to these orientations.

Minority constituents in garnets may include Pb impurity from the flux and Pt impurity from the crucible. Monovalent, divalent, tetravalent and pentavalent dopants are added to adjust the stoichiometry including, but not limited to K, Na, Sr, Ca, Mg, Si, Ge, Ti, V and Nb. Transition metals may occur as impurities or as dopants including those previously listed and Co, Cr, Mn, Ni, Cu, Ru, Rh and Ir.

### COMPARATIVE EXAMPLE NUMBER 1

Hansen et al. (R. W. Hansen, L. E. Helseth, A. Solovyev, E. Il'Yashenko and T. H. Johansen, Journal of Magnetism and Magnetic Materials 272-276 (2004) p. 2247) give melt compositions for the growth of thin (BiLu)₃(FeGa)₅O₁₂ magnetooptic indicator films with negative growth-induced anisotropy. The following composition was deemed optimal: PbO 72.0 mole %, Bi₂O₃ 15.0 mole %, B₂O₃ 2.6 mole %, Fe₂O₃ 8.5 mole %, Ga₂O₃ 1.5 mole %, Lu₂O₃ 0.4 mole %. This melt was used to grow thin magnetooptic indicator films 2-3 μm thick on a substrate of gadolinium gallium garnet with a (100) orientation. The films had a small negative uniaxial anisotropy that may have come in part from stress-induced anisotropy. The growth temperature was 720° C., which implies a very high undercooling and high growth rate. The rotation rate of the substrate during growth was 120 rpm, which violently agitates the melt. To eliminate homogeneous nucleation, the melt had to be stirred at 1050-1100° C. for two hours between runs to make sure all the garnet was in solution.

### COMPARATIVE EXAMPLE NUMBER 2

Shirai et al. (U.S. Pat. No. 5,512,193) formulated a melt as their Embodiment 6 as follows: PbO 60.50 mole %, Bi₂O₃ 20.25 mole %, B₂O₃ 8.65 mole %, Fe₂O₃ 8.92 mole %, Ga₂O₃ 1.22 mole %, Lu₂O₃ 0.23 mole %. Gd₂O₃ 0.23 mole %. This melt was used to grow a film 72 μm thick of approximate composition Bi_{1.55}Gd_{0.74}Lu_{0.71}Fe_{4.22}Ga_{0.78}O₁₂ on a CMZ:GGG substrate of (111) orientation. The film had a positive perpendicular uniaxial anisotropy. The growth temperature was 750° C. The sum of the gallium and aluminum concentrations (no aluminum in this composition) is between 0.7 and 1.25 atoms per formula unit to give a low saturating field. The bismuth concentration is between 1.1 and 1.6 atoms per formula unit and the ratio between Lu and Gd is between 0.5 and 1.35.

A preferred embodiment of the current invention is a melt with the following composition: PbO 44.90 mole %, Bi₂O₃ 33.67 mole %, B₂O₃ 10.72 mole %, Fe₂O₃ 9.31 mole %, Ga₂O₃ 0.67 mole %, Lu₂O₃ 0.27 mole %. Gd₂O₃ 0.46 mole %. Films are grown up to 330 μm thickness of approximate composition Bi_{1.13}Gd_{1.36}Lu_{0.51}Fe_{4.55}Ga_{0.45}O₁₂ on CMZ:GGG substrates of (100) orientation. The films have a negative planar uniaxial anisotropy. The growth temperature is about 753° C., the saturation temperature is about 787° C., the rotation rate is 40 RPM and the growth rate is about 13 μm/hour.

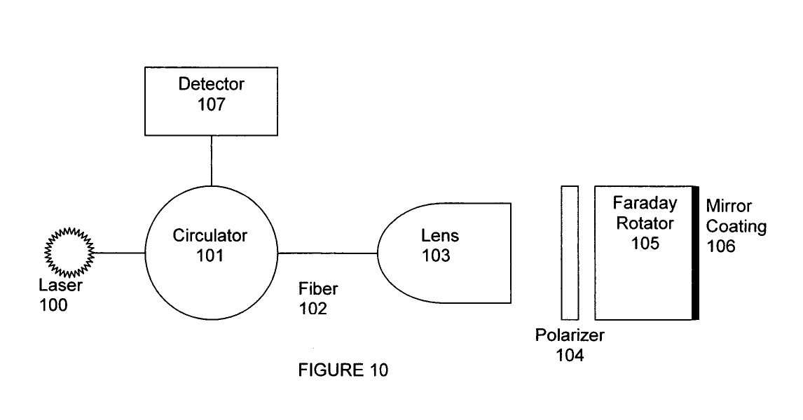

A device utilizing the current invention is a magnetic field sensor of design as in FIG. 10. Such a design is common to many magnetic field sensors, but the use of thick film garnet of negative planar uniaxial anisotropy provides improved performance over the prior art. The incoming beam from the light source 100 passes through the circulator 101 and is passed on to the device through the fiber 102 and the lens 103. The incoming polarizer 104 is aligned to the polarization of the incoming light and passes all of the incoming light. The light then passes through the Faraday rotator 105, is reflected by the mirror on the backside 106, passes through the Faraday rotator 105 again and strikes the polarizer 104. The amount of light passed in reverse is governed by the amount of rotation the light has experienced in two passes through the Faraday rotator 105 and the polarization that it therefore presents to the polarizer 104. The light that is passed is focused by the lens 103 on the fiber 102 and propagated back to the circulator 101. The outgoing beam is directed by the circulator to the detector 107.

The Faraday rotator of the present device is typically fabricated to provide 45 degrees of polarization rotation at the wavelength of interest when fully magnetically saturated perpendicular to the plane of the film and has its external surface anti-reflection coated. In the present embodiment, a Faraday rotator with planar anisotropy is used such that all the domains will provide the same Faraday rotation. Because the magnetooptic effect is non-reciprocal, the polarization rotation depends only on the direction of magnetization and not on the direction of light propagation. Thus the polarization rotation of two passes in and out is twice that of a single pass. In the demagnetized planar state, the Faraday rotator will have zero rotation and pass all the light. The insertion loss is only the minimal value of the garnet approximately 1% per pass or approximately 2% total plus any small losses from the other components and the assembly. In the fully magnetized state in either direction, the polarization will be 2×45=90 degrees and it will not pass the 0 degree polarizer 104. Thus the device will have a full range of variation from >95% to 0%.

In contrast, this device design is even more sensitive to perpendicular domains than was derived for the general case. The 50% loss only applies when the two passes through the Faraday rotator are random as to location. If the beam is well collimated and each returning beam passes through the same domain, each beam will experience ±90 degrees of Faraday rotation and none of the light will pass the 0 degree polarizer on return. Typically Faraday rotator mirror magnetic field sensors with perpendicular garnet experience some combination of these two and very high losses. Thus planar garnet films provide a great advantage in this design for magnetic field and current sensor applications.

1-7. (canceled)

8. A thick film garnet having a thickness greater than about 50 microns and growth-induced anisotropy K_{g}<0 grown by liquid phase epitaxy on a (100)-oriented substrate, the substrate selected from the group consisting of gadolinium gallium garnet, europium gallium garnet, samarium gallium garnet and neodymium gallium garnet.

9. The thick film garnet of claim 8 and having a composition represented by a general equation:
R1_{3-x-y-v}BiₓR2_{y}AᵥFe_{5-z-w}D_{z}E_{w}O₁₂;
where R1 denotes at least one rare earth element selected from the group consisting of:
Nd, Eu, Gd, Tb, and Ho;
R2 denotes at least one rare earth element selected from the group consisting of:
Ho, Tm, Yb and Lu;
D denotes at least one element selected from the group consisting of:
Ga and Al;
A and E are one or more minority constituents arising from impurities and doping x, y, v, z and w are numerical values in the ranges:
1.2>x>0.7;
y>0.1,
z<1.1;
v<0.1; and
w<0.1.

10. The thick film garnet film of claim 8 and having a composition represented by a general equation:
Lu_{3-x-z}BiₓA_{z}Fe_{5-w-v-t}GA_{w}AlᵥEₜO₁₂;
where A and D denote any other element of minority concentrations; and x, z, w, v and t are numerical values in the ranges;
0.8<x<1.2;
0.5<w+v<1.5;
z<0.1; and
t<0.1

11. A thick film garnet having a thickness greater than about 50 microns grown by liquid phase epitaxy wherein the direction of light propagation is in the plane of the film, the light propagation is non-waveguiding and the extinction ration of the material exceeds 30 dB.
